(19) United States
(12) Patent Application Publication
(10) Pub. No.: US 2003/0209635 A1
(43) Pub. Date: Nov. 13, 2003

(54) Electric dipole moment propulsion system

(76) Inventor: John Quincy St. Clair, San Juan, PR (US)

Correspondence Address: John St. Clair, Hyperspace Research Institute, 52 Kings Court, 4A, San Juan, PR, 00911, US

(21) Appl. No.: 10/142,239

(22) Filed: May 9, 2002

(51) Int. Cl. B64G 1/24; F02K 1/00; F03H 3/00; F02K 5/00; F02K 7/00; F02K 11/00

(52) U.S. Cl. 244/164

(57) ABSTRACT

This invention relates to a spacecraft propulsion system utilizing a rotating octagon of trapezoidal electrically charged flat panels to create an electric dipole moment that generates lift on the hull. On the interior side of each panel are electrostatically charged rods which produce a planar electric field that emerges from holes in the panel to form an ellipsoidal potential energy bubble on the outside of the hull. The rotating hull dipole moment generates a magnetic moment which, together with the magnetic field gradient developed by the rotating electric field of the electrostatically charged panels, produces said lift force. The potential energy field is enhanced by using a double cladding of hull material with different ranges of permittivities.

### BRIEF SUMMARY OF THE INVENTION

The invention, which is the object of my present application, is a spacecraft utilizing trapezoidal electrostatically charged flat plate panels which form a pyramidal hull. A panel contains three holes each of which produces a potential energy ellipsoidal bubble that creates an electric dipole moment. The rotation of the hull generates a magnetic moment and a magnetic field gradient in the vertical direction that produces a lift force on the spacecraft.

### REFERENCE PAPERS

Gravitation, John Archibald Wheeler

Levitron, Hones, U.S. Pat. No. 5,404,062.

Classical Electrodynamics, John David Jackson, Chapter 3.12, Mixed Boundary Conditions; Conducting Plan with a Circular Hole.

### BACKGROUND OF THE INVENTION

I was reading Dr. Jackson's book about the formation of a potential energy bubble by a hole in a conducting plane, a picture of which is shown on page 134 of his book. It turns out that this bubble creates an electric dipole moment from which it is possible to get a magnetic moment. Then I realized that a rotating tilted hull having a velocity gradient would produce a magnetic field gradient in the vertical direction. This combination produces a lift force on the spacecraft.

I did quite a number of computer simulations of the bubble using an electromagnetic simulation software program. I found that the hole in the plate doesn't produce a very large potential energy bubble. So I created another simulation where the hole protrudes out of the plate in an ellipsoidal shape. This produces a much larger field. I then found that using a double cladding, in which each layer has a different permittivity, confined the field to the outside of the hull for even better results.

The planar potential energy is created by a grid of electrically charged wires or rods running the length of each panel. As shown by Feynman, the circular potential energy from each rod very quickly sums to form a flat sheet of energy which emerges from the hole to form said potential energy bubble.

### SUMMARY OF THE INVENTION

The invention relates to a spacecraft utilizing a rotating octagon of trapezoidal electrically charged flat plate panels to form a hull in the shape of a pyramid. Each panel has three protruding ellipsoidal bubbles that produce an electric dipole moment from a planar potential energy field created by a group of charged rods parallel to the panel. Because the panels are tilted and the hull is rotating, there is a tangential velocity gradient in the vertical direction. This creates the magnetic moment. Because the hull rotates, the radial electric field produces a magnetic field gradient in the vertical direction. This combination of magnetic moment and magnetic field gradient produces a lift force on the hull of the spacecraft.

On the underside of each panel is a group of high voltage electrically charged rods which run parallel to the panel. These wires or rods produce a planar electrical potential field underneath the holes in the panel. This potential energy field then bubbles out of the holes in the panel to create a large ellipsoidal potential energy field above the hull. The potential energy bubble carries an electric dipole moment which when rotated with the hull generates a magnetic moment in the vertical direction.

### STATEMENT REGARDING FEDERALLY SPONSORED RESEARCH OR DEVELOPMENT

Not Applicable.

### A BRIEF DESCRIPTION OF THE DRAWINGS

FIG. 1. Perspective view of electric dipole moment spacecraft.

FIG. 2. Perspective exploded view of one panel with the ellipsoidal domes, flat hull panel with three holes, the charged rod grid and the planar potential energy field.

FIG. 3. Flat potential energy field produced by electrically charge wire rods.

FIG. 4. The potential in terms of the electric field of the rods times distance from rods.

FIG. 5. Cylindrical coordinates {t, r, θ, z}.

FIG. 6. Ellipsoidal potential energy field emerging from hole in plate. This produces an electric dipole moment.

FIG. 7. Computer simulation of potential energy bubble.

FIG. 8. Centroid of an ellipse needed to calculate dipole moment.

FIG. 9. The charge of the hole.

FIG. 10. The units are charge.

FIG. 11. The dipole moment p.

FIG. 12. The magnetic moment in terms of the dipole moment and hull surface velocity.

FIG. 13. The magnetic moment in tensor notation.

FIG. 14. The lift force on the hull is equal to the gradient of the dot product of the magnetic moment and magnetic field.

FIG. 15. Maxwell's equation for the electric field changing with time.

FIG. 16. The components of Maxwell's equation.

FIG. 17. The radial electric field rotates with the angular velocity of the hull.

FIG. 18. The magnetic field is equal to the velocity of the hull times the electric field of the hull divided by the speed of light squared.

FIG. 19. The magnetic field gradient is proportional to the tangential velocity gradient along the panel.

FIG. 20. The hull profile needed to get the velocity gradient.

FIG. 21. The three vectors of the electric dipole moment (A), the tangential velocity of the hull (B), and the magnetic moment (C).

FIG. 22. The magnetic moment components in the radial and vertical direction. The dot product of the vertical magnetic moment with the magnetic field gradient is the lift force.

FIG. 23. Cross section of dome showing two layer cladding with different permittivities to enhance potential energy field.

FIG. 24. Computer simulation of potential energy field around dome.

### DETAILED DESCRIPTION OF THE INVENTION

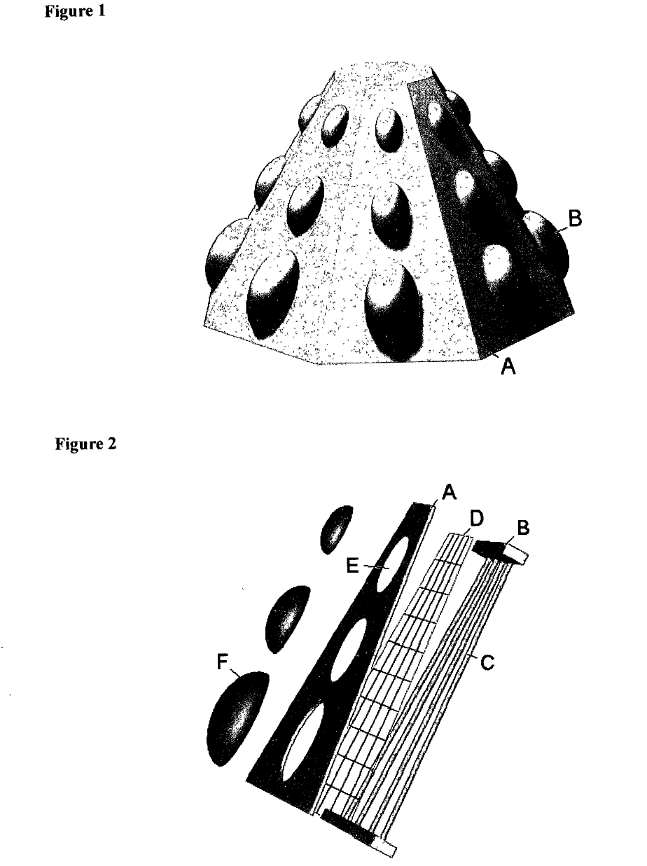

1. Referring to FIG. 1, the spacecraft is a rotating octagon of trapezoidal electrostatically charged flat panels which form a closed hull (A). Each panel has three ellipsoidal domes (B) of varying size centrally located along the major length of the panel. The purpose of the dome is to create a large ellipsoidal potential energy bubble over the hull which develops an electrical dipole moment. Because the hull is rotating, a magnetic moment is created in the vertical direction. A magnetic field gradient created by the rotating electric field on the hull in combination with said magnetic moment produces a lift force on the hull.

2. Referring to FIG. 2, the trapezoidal hull panel (A) contains three ellipsoidal holes (E). A group of wires or rods (C) running parallel to and just underneath the panel are electrically charged to a high voltage at the end terminals (B). Said rods produce a planar potential energy field (D) just under the holes in the panel. The field emerges from the holes in the shape of an ellipsoidal bubble and is amplified by an ellipsoidal dome (F) on the outside of the hull.

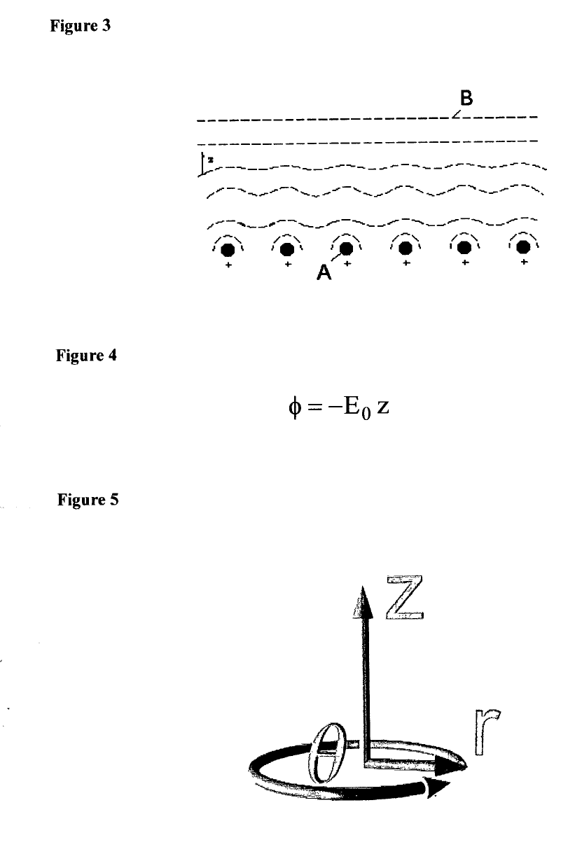

3. Referring to FIG. 3, the group of parallel rods (A) are given a linear charge λ in units of charge per meter. The electric field E developed by the rod is the linear charge divided by the circumference of a circle of radius r around the wire times the permittivity ε of space. The analysis of this arrangement shows that within a few grid width spacings, the potential energy field φ has become planar (B) in the z-direction given by the equation in FIG. 4.

4. The forthcoming analysis is done in cylindrical coordinates, FIG. 5.

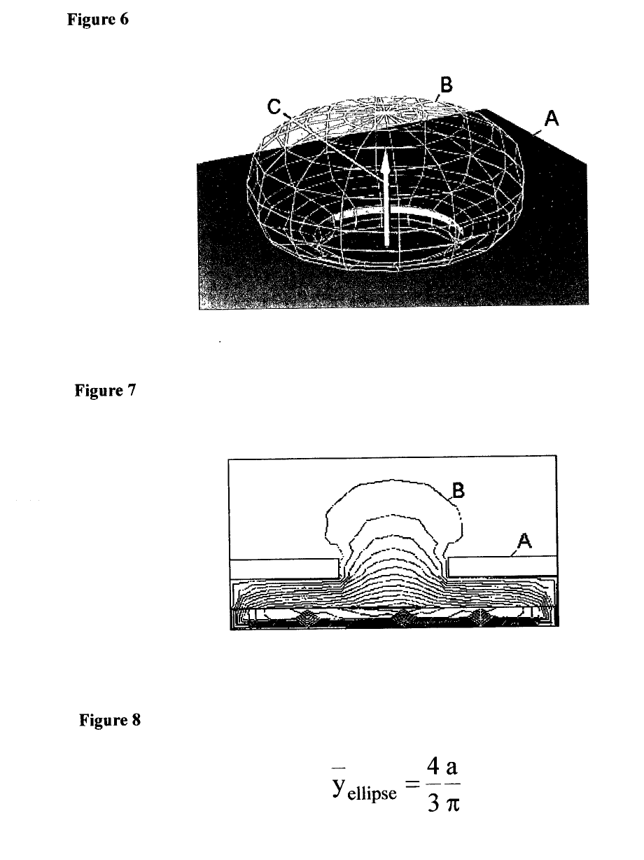

5. Referring to FIG. 6, the ellipsoidal potential energy (B) emerges through the hole in the panel plate (A). In doing so it creates an electrical dipole moment (C) shown by the arrow normal to the hole area. The theoretical analysis matched a computer simulation of this emergence of the bubble (B) through plate (A), as shown in FIG. 7.

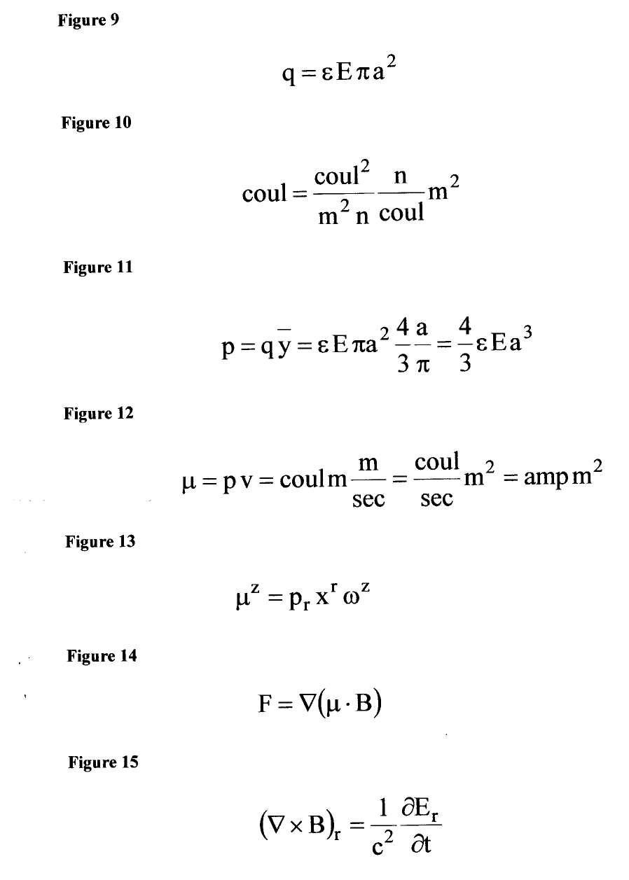

6. Because the bubble has the shape of an ellipse, the centroid of the bubble would be four thirds the radius a divided by π as given in FIG. 8. The electric dipole moment is then given as the charge times said centroid. The charge of the hole is equal to the permittivity times the electric field emerging from the hole times the area of the hole as seen in the equation of FIG. 9 with the units of charge, FIG. 10.

7. The electric dipole moment is said centroid times said charge, as seen in the equation given in FIG. 11 and having units of coulomb-meter. Notice that the electric dipole moment p times a velocity v is equal to a magnetic moment μ which is what creates the lift force on the hull as shown in the next FIG. 12.

8. The rotating hull creates the electric dipole moment velocity so that the entire hull develops a magnetic moment. In tensor notation, FIG. 13, the magnetic moment is in the vertical direction because there is a radial component of the electric dipole moment times the velocity. The velocity is the radius r in the radial direction times the angular velocity in the z-direction.

9. The force on the hull is the gradient of the dot product of the magnetic moment with the magnetic B field given in equation FIG. 14.

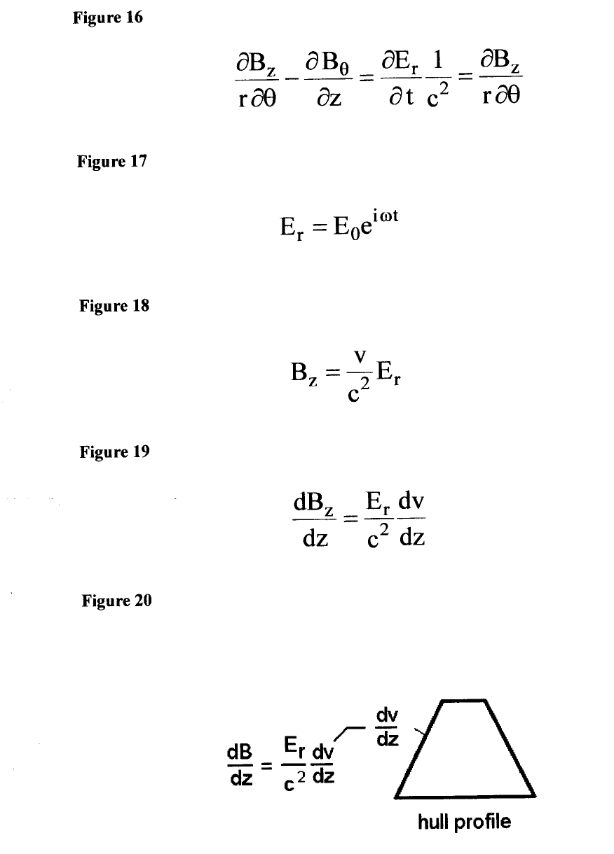

10. By electrically charging the hull of the vehicle, a radial electric field is produced. By rotating the hull, the radial electric field changes with time. Thus Maxwell's equations will involve the curl of the magnetic field in the radial direction because the radial electric field is varying with time. Maxwell's equation is seen in FIG. 16.

11. The cross product involves the magnetic field in the theta direction which is zero. The electric field varies with time as shown in FIG. 17. Substituting the derivative of the electric field and integrating with respect to angle theta gives the vertical magnetic field as the tangential velocity times the radial field divided by the speed of light squared (FIG. 18).

12. Now the force on the hull is the gradient of the magnetic moment times the magnetic field. In the equation for the magnetic field, the only available variable to work with in order to get a gradient is the velocity. To me this was the surprise in this invention. The velocity had to be a function of the height of the hull (FIG. 19) which meant that the hull had to be in the shape of a pyramid, FIG. 20. Using eight flat sides keeps the radial electric field pointing in the same direction in each panel. Each panel has three domes to produce the magnetic moment for a total of 24 magnetic moment generators.

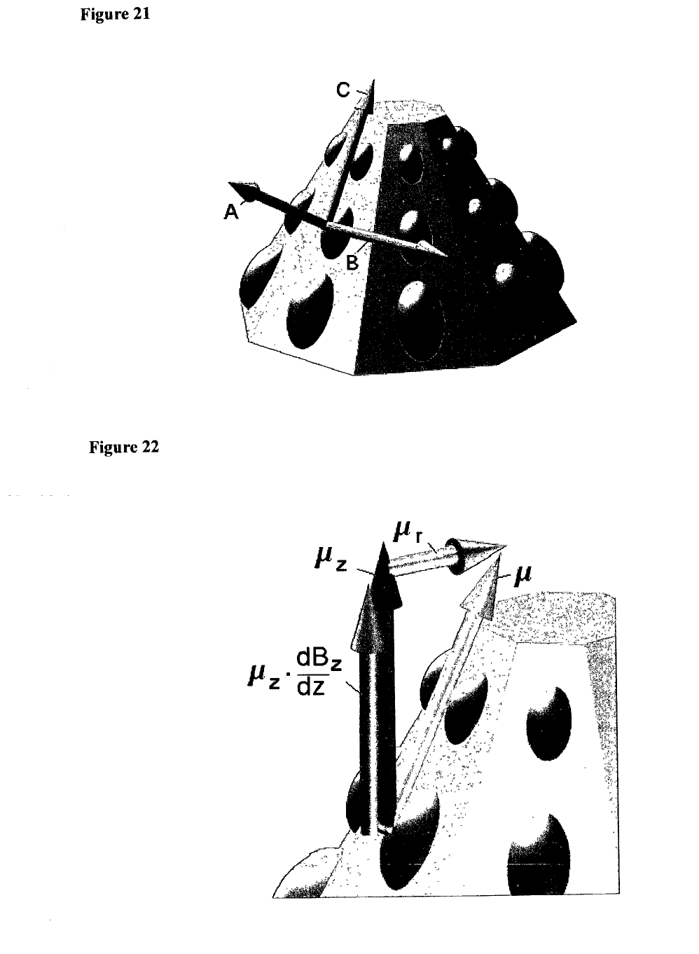

13. Referring to FIG. 21, the electric dipole moment (A) points in the radial direction, the rotating hull produces a tangential velocity (B), and the result is a magnetic moment (C) along the panel.

14. Because the magnetic moment is parallel to the panel, there are vertical and radial components of the magnetic moment. The vertical magnetic moment creates the dot product with the magnetic field gradient, which is equal to the lift force, as depicted in FIG. 22.

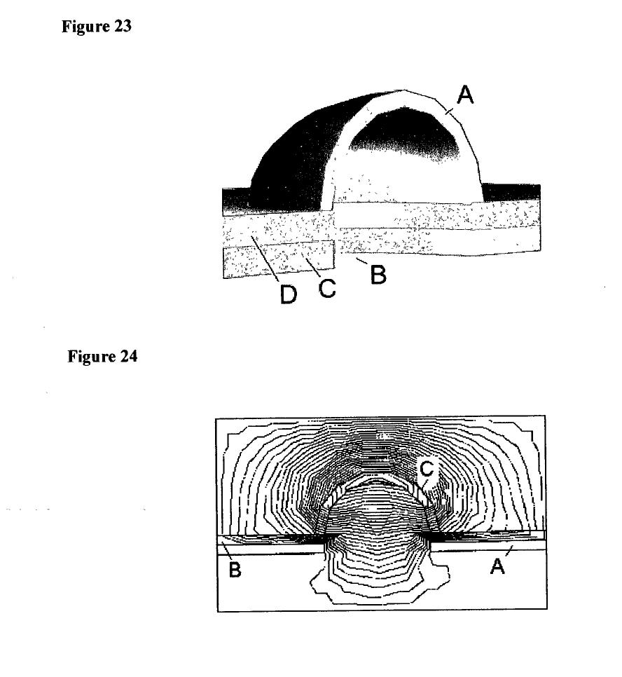

15. FIG. 23 shows a cross-section of the dome (A) and the plate hole (B) with double cladding to enhance the field as determined by computer simulation. The upper cladding (D) has a low relative permittivity in the range of 2 to 40, and the lower layer has a high relative permittivity in the range of 1200 to 4000. This dome and cladding configuration creates a much larger electric dipole moment compared to a hole in the plate, comparing FIG. 23 to that of FIG. 7. The wavy lines are the equi-potential energy lines from the dome (C) and the upper layer (B) and the lower level (A).

What I claim as my invention is:

1. A spacecraft having a rotating octagon of trapezoidal electrostatically charged flat panels which form a closed hull in the shape of a pyramid.

2. Said panels each having three holes covered by three ellipsoidal domes of varying size centrally located along the major length of the panel.

3. A grid of high voltage electrostatically charged rods located on the interior side of each panel such that a planar potential field is produced parallel to and under each hole of said panel.

4. Said domes and holes in panel produce an ellipsoidal potential energy field carrying an electric dipole moment on the outside of the hull.

5. Said rotating hull together with electric dipole moment produce a magnetic moment in the vertical direction.

6. Said rotating charged hull produces an electric field in the radial direction which generates a corresponding magnetic field gradient in the vertical direction proportional-to the velocity gradient of the sloping panels of the hull.

7. Combined magnetic moment and magnetic field produce lift on the hull.

8. Dome material and surface layer cladding having different permittivities which enhance said electric dipole moment.

9. Use of magnetic vortex generator to bring in low density hyperspace energy in order to increase the field strengths as described in my patent applications Magnetic Vortex Wormhole Generator and Magnetic Vortex Generator.
